(19) United States
(12) Patent Application Publication
(10) Pub. No.: US 2023/0045921 A1
(43) Pub. Date: Feb. 16, 2023

(54) CURABLE PERFLUOROPOLYETHER ADHESIVE COMPOSITION, AND ADHESIVE AND ADHESIVE TAPE INCLUDING CURED PRODUCT THEREOF

(71) Applicant: SHIN-ETSU CHEMICAL CO., LTD., Tokyo (JP)

(72) Inventors: Hiroyuki YASUDA, Tomioka-shi (JP); Koichi YAMAGUCHI, Takasaki-shi (JP)

(73) Assignee: SHIN-ETSU CHEMICAL CO., LTD., Tokyo (JP)

(21) Appl. No.: 17/783,123

(22) PCT Filed: Nov. 26, 2020
(86) PCT No.: PCT/JP2020/043943

§ 371 Date: Jun. 7, 2022

(30) Foreign Application Priority Data
Dec. 17, 2019 (JP) 2019-227304

(51) Int. Cl. C09J 129/10; C09J 11/06; C09J 183/04

(52) U.S. Cl. CPC C09J 129/10; C09J 11/06; C09J 183/04

(57) ABSTRACT

A curable perfluoropolyether adhesive composition containing the following components (A) to (C): (A) 100 parts by mass of a linear perfluoropolyether compound having at least two alkenyl groups per molecule and having a perfluoropolyether structure containing a repeating unit represented by —CₐF₂ₐO— in a main chain, “a” being an integer of 1 to 6; (B) an effective curing amount of an organosilicon compound having at least two silicon-bonded hydrogen atoms per molecule; and (C) a catalytic amount of a hydrosilylation-reaction catalyst, where a cured product of the curable perfluoropolyether adhesive composition is an adhesive having adhesion of less than 0.5 N/25 mm.

### TECHNICAL FIELD

The present invention relates to: a curable perfluoropolyether adhesive composition (hereinafter, referred to as a perfluoropolyether adhesive composition), a product of which is an adhesive (cured perfluoropolyether rubber or cured perfluoropolyether gel) having excellent heat resistance, oil resistance, chemical resistance, solvent resistance, low-temperature properties, moisture resistance, low gas permeability, and so forth, and in particular, low adhesion; an adhesive including a cured product of the curable perfluoropolyether adhesive composition; and an adhesive tape including a cured product of the curable perfluoropolyether adhesive composition.

### BACKGROUND ART

Conventionally, it is proposed that a good cured product having well-balanced properties of heat resistance, chemical resistance, solvent resistance, water repellency, oil repellency, weatherability, etc. can be obtained from a composition containing: a linear perfluoropolyether compound having at least two alkenyl groups per molecule and having a perfluoropolyether structure in a main chain; an organosilicon compound having two or more H—SiOSiO structures per molecule; and a hydrosilylation-reaction catalyst (Patent Document 1, Patent Document 2).

Meanwhile, adhesives are used in various situations, mainly labels and adhesive tapes to be attached to products. Recently, uses are expanding accompanying progress in electronic terminal-related technology, and examples include adhesive films for protecting displays and films for protection during product production processes. Furthermore, adhesives are not only used for surface protection, but also for optical members, making use of the transparency of the material. In addition, uses on the inside of products, for example, Optical Clear Adhesive Tapes (OCA tapes) are also being developed.

Main classifications of adhesives include acrylic types, rubber types, silicone types, etc., and each type has advantages and disadvantages. Silicone adhesives have a disadvantage regarding costs compared with acrylic types or rubber types, but have better properties such as heat resistance, cold resistance, weatherability, chemical resistance, and electric insulation property than the other two types of adhesives.

Recently, terminals such as mobile phones have become widespread. Most adhesive films for protecting the displays of such terminals use silicone adhesives. Silicone has favorable wettability to an adherend owing to characteristics thereof. Therefore, air bubbles do not get caught when bonding the adhesive film on and the adhesive film does not shift or peel off of its own accord; besides it is also possible to rebond the adhesive film since reworkability is good (Patent Document 3). The same is also true regarding protective films for use during product production processes, and heat resistance and so forth are further required. Therefore, a large amount of adhesive film using silicone adhesives used.

In addition, among mobile phones, terminals called smartphones, having higher performance than conventional mobile phones, are rapidly spreading, and many smartphones until now can be operated by touching a display called a touch screen instead of conventional buttons. Similar terminals include tablets, which are computers that can be carried easily and have a touch screen. Owing to the spreading of these terminals, the area or displays has become large, and accordingly, demands for adhesive films for protecting the screen are rising.

However, although such silicone adhesives have sufficient performance as they are for most uses, there has been strong desire for the emergence of an adhesive composition excellent in chemical resistance and solvent resistance for use on barcode labels and so forth that require further chemical resistance and solvent resistance, used in engines of vehicles and in processes of clinical examination and pathological examination.

In these circumstances, a curable perfluoropolyether adhesive composition is proposed (Patent Document 4). It is shown that this composition has excellent heat resistance, weatherability, water repellency, oil repellency, and so forth, and also gives a cured product excellent in chemical resistance and solvent resistance. However, the curable perfluoropolyether adhesive composition has adhesion of 0.5 N/25 mm or more, and therefore, is not suited to low-adhesion usage, by which an adherend can be prevented from being easily damaged when the adherend has low strength.

### CITATION LIST

### Patent Literature

Patent Document 1: JP 2990646 B2

Patent Document 2: JP 2000-248166 A

Patent Document 3: JP H07-197008 A

Patent Document 4: JP 2019-38904 A

### SUMMARY OF INVENTION

### Technical Problem

The present invention has been made in view of the above circumstances, and an object thereof is to provide: a curable perfluoropolyether adhesive composition that gives a cured product having excellent heat resistance, weatherability, water repellency, oil repellency, etc., chemical resistance, and solvent resistance, in particular, the cured product having low adhesion; an adhesive containing a cured product of the composition; and an adhesive tape containing a cured product of the composition.

### Solution to Problem

To achieve the object, the present invention provides a curable perfluoropolyether adhesive composition comprising the following components (A) to (C):

(A) 100 parts by mass of a linear perfluoropolyether compound having at least two alkenyl groups per molecule and having a perfluoropolyether structure containing a repeating unit represented by —CₐF₂ₐO— in a main chain, “a” being an integer of 1 to 6;
(B) an effective curing amount of an organosilicon compound having at least two silicon-bonded hydrogen atoms per molecule; and
(C) a catalytic amount of a hydrosiylation-reaction catalyst,

wherein a cured product of the curable perfluoropolyether adhesive composition is an adhesive having adhesion (low adhesion) of less than 0.5 N/25 mm.

A curable perfluoropolyether adhesive composition containing the components (A) to (C) as in the present invention gives a cured product (an adhesive) excellent in heat resistance, weatherability, water repellency, oil repellency, oil resistance, low-temperature properties, moisture resistance, low gas permeability, etc. Moreover, the cured product is particularly excellent in chemical resistance and solvent resistance, while also having adhesion of less than 0.5 N/25 mm. An adhesive tape including a cured product having adhesion of less than 0.5 N/25 mm can be peeled from a substrate without damaging the substrate even when bonded to a fragile substrate. Furthermore, such a curable perfluoropolyether adhesive composition of the present invention containing the components (A) to (C) can give cured rubber (cured perfluoropolyether rubber).

In addition, the present invention provides a curable perfluoropolyether adhesive composition comprising the following components (A) to (D):

(A) 100 to 40 parts by mass of a linear perfluoropolyether compound having at least two alkenyl groups per molecule and having a perfluoropolyether structure containing a repeating unit —CₐF₂ₐO— in a main chain, “a” being an integer of 1 to 6;
(D) 0 to 60 parts by mass of a polyfluoromonoalkenyl compound having one alkenyl group per molecule and having a perfluoropolyether structure in a main chain, a total amount of the components and (D) being 100 parts by mass;
(B) an effective curing amount of an organosilicon compound having at least two silicon-bonded hydrogen atoms per molecule; and
(C) a catalytic amount of a hydrosilylation-reaction catalyst,

wherein a cured product of the curable perfluoropolyether adhesive composition is an adhesive having adhesion of less than 0.5 N/25 mm.

A curable perfluoropolyether adhesive composition containing the components (A) to (D) as in the present invention gives a cured product (an adhesive) excellent in heat resistance, weatherability, water repellency, oil repellency, oil resistance, low-temperature properties, moisture resistance, low gas permeability, etc. Moreover, the cured product is particularly excellent in chemical resistance and solvent resistance, while also having adhesion of less than 0.5 N/25 mm. An adhesive tape including a cured product having adhesion of less than 0.5 N/25 mm can be peeled from a substrate without damaging the substrate even when bonded to a fragile substrate. Furthermore, such a curable perfluoropolyether adhesive composition of the present invention containing the components (A) to (D) can give cured rubber or cured gel (cured perfluoropolyether rubber or cured perfluoropolyether gel).

In this case, the component (D) is preferably a polyfluoromonoalkenyl compound represented by the following, general formula (2):

Rf¹—(X′)ₚ—CH═CH₂ (2)

wherein X′ represents —CH₂—, —OCH₂—, —CH₂OCH₂—, or —CO—NR²—Y′—, Y′ is a group represented by —CH₂— or the following structural formula (Z′),

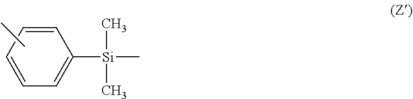

being a dimethylphenyisilylene group in an ortho-, meta-, or para-position, R² represents a hydrogen atom, a methyl group, a phenyl group, or an allyl group, “p” is 0 or 1, Rf¹ is a perfluoropolyether structure represented by a general formula F—[CF(CF₃)CF₂O]_{w}—CF(CF₃)—, and “w” represents an Integer of 1 to 500.

When the composition contains such a component (D), the curable perfluoropolyether adhesive composition can give a cured product (an adhesive) more excellent in chemical resistance and solvent resistance.

Furthermore, the component (A) is preferably a linear perfluoropolyether compound represented by the following general formula (1):

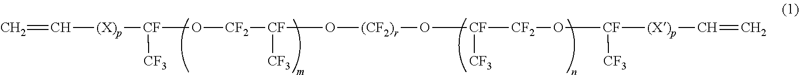

wherein X represents —CH₂—, —CH₂O—, —CH₂OCH₂—, or —Y—NR¹—CO—, Y is a group represented by —CH₂— or the following structural formula (Z) , R¹ represents a hydrogen atom, a methyl group, a phenyl group, or an allyl group, X′ represents —CH₂—, —OCH₂—, —CH₂OCH₂—, or —CO—NR²—Y′—, Y′ is a group represented by —CH₂— or the following structural formula (Z′), R² represents a hydrogen atom, a methyl group, a phenyl group, or an allyl group, “p” is independently 0 or 1, “r” is an integer of 2 to 6, “m” and “n” each represent an integer of 0 to 600, a sum of “m” and “n” further being 50 to 600,

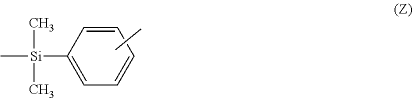

(Z) being a dimethylphenylsilyiene group in an ortho-, meta-, or para-position, and

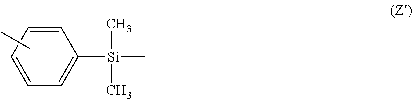

(Z′) being a dimethylphenylsilylene group in an ortho-, meta-, or para-position.

When the composition contains such a component (A), the curable perfluoropolyether adhesive composition gives a cured product (an adhesive) more excellent in chemical resistance and solvent resistance, and also has sufficient adhesion for providing the adhesion necessary for an adhesive tape.

For example, the component (A) is preferably a linear perfluoropolyether compound represented by the general formula (1),

the curable perfluoropolyether adhesive composition preferably contains 0 to 20 parts by mass of the component (D) based on 100 to 80 parts by mass of the component (A), provided that a total of the component (A) and the component (D) is 100 parts by mass,

and the component (B) is preferably a fluorine-containing organohydrogenpolysiloxane having a cyclic siloxane structure.

Alternatively, the component (A) is preferably a linear perfluoropolyether compound represented by the general formula (1),

the curable perfluoropolyether adhesive composition preferably contains 21 to 45 parts by mass of the component (D) based on 79 to 55 parts by mass of the component (A), provided that a total of the component (A) and the component (D) 100 parts by mass,

and the component (B) is preferably a fluorine-containing polyorganohydrogensiloxane having a linear and/or branched siloxane structure.

Alternatively, the component (A) is preferably a linear perfluoropolyether compound containing a divalent perfluoropolyether structure including repeating units of a (CF₂O) unit and a (CF₂CF₂O) unit in a main chain,

the curable perfluoropolyether adhesive composition preferably contains 0 to 50 parts by mass of the component (D) based on 100 to 50 parts by mass of the component (A), provided that a total of the component (A) and the component (D) is 100 parts by mass,

and the component (B) is preferably a fluorine-containing organohydrogenpolysiloxane having a linear and/or branched siloxane structure.

Alternatively, the component (A) is preferably a linear perfluoropolyether compound represented by the general formula (1), the linear perfluoropolyether compound containing a divalent perfluoropolyether structure including repeating units of a (CF₂O) unit and a (CF₂CF₂O) unit in a main chain,

the curable perfluoropolyether adhesive composition preferably contains 0 to 50 parts by mass of the component (D) based on 100 to 50 parts by mass of the component (A), provided that a total of the component (A) and the component (D) 100 parts by mass,

and the component (B) is preferably a fluorine-containing organohydrogenpolysiloxane having a linear and/or branched siloxane structure.

The compositions of these examples can give a cured product (an adhesive) more excellent in chemical resistance and solvent resistance, and an adhesive tape including, the obtained cured product can be peeled from a substrate without damaging the substrate even when bonded to a fragile substrate.

Furthermore, the cured product of the curable perfluoropolyether adhesive composition is preferably a non-conductive adhesive having a volume resistivity of 1×10⁹ Ω·cm or more.

The inventive curable perfluoropolyether adhesive composition can be used suitably as a material for such a non-conductive adhesive.

In addition, an adhesive comprising the cured product of the above-described curable perfluoropolyether adhesive composition is provided.

As described, the inventive curable perfluoropolyether adhesive composition can be used as an adhesive.

In addition, the present invention provides an adhesive tape comprising a cured layer of the above-described curable perfluoropolyether adhesive composition provided on a substrate.

By providing a cured layer of the inventive curable perfluoropolyether adhesive composition (an adhesive layer including cured perfluoropolyether rubber or cured perfluoropolyether gel) on a substrate in this manner, the product can be used as an adhesive tape having a non-conductive adhesive laver.

### Advantageous Effects of Invention

As described above, the inventive perfluoropolyether adhesive composition can give a rubber-form or gel-form cured product (adhesive) excellent in heat resistance, weatherability, water repellency, oil repellency, oil resistance, low-temperature properties, moisture resistance, low gas permeability, etc., particularly excellent in chemical resistance and solvent resistance, and also having adhesion of less than 0.5 N/25 mm (low adhesion). An adhesive tape including a cured product having adhesion of less than 0.5 N/25 mm (a low-adhesion tape) can be peeled from a substrate without damaging the substrate even when bonded to a fragile substrate.

### DESCRIPTION OF EMBODIMENTS

As described above, there have been demands for the development of: a curable perfluoropolyether adhesive composition that gives a low-adhesion type cured product (adhesive) that is excellent in heat resistance, weatherability, water repellency, oil repellency, etc., is particularly excellent in chemical resistance and solvent resistance, and furthermore, can avoid damaging an adherend when the adherend has low strength; and an adhesive including a cured product of the curable perfluoropolyether adhesive composition.

To achieve the object, the present inventors have earnestly studied and found out that by using a particular perfluoropolyether adhesive composition according to the present invention, it is possible to obtain a low-adhesion adhesive composition that gives a rubber-form or gel-form cured product (cured perfluoropolyether rubber or cured perfluoropolyether gel) more excellent in chemical resistance and solvent resistance than conventional silicone adhesives, and arrived at the present invention.

Accordingly, the present invention gives the following curable perfluoropolyether adhesive composition, an adhesive including a cured product of the curable perfluoropolyether adhesive composition, and an adhesive tape including a cured product of the curable perfluoropolyether adhesive composition.

[1]

A curable perfluoropolyether adhesive composition comprising the following components (A) to (C):

(A) 100 parts by mass of a linear perfluoropolyether compound having at least two alkenyl groups per molecule and having a perfluoropolyether structure containing a repeating unit represented by —CₐF₂ₐO— in a main chain, “a” being an integer of 1 to 6;
(B) an effective curing amount of an organosilicon compound having at least two silicon-bonded hydrogen atoms per molecule; and
(C) a catalytic amount of a hydrosilylation-reaction catalyst,

wherein a cured product of the curable perfluoropolyether adhesive composition is an adhesive having adhesion of less than 0.5 N/25 mm.

[2]

A curable perfluoropolyether adhesive composition comprising the following components (A) to (D):

(A) 100 to 40 parts by mass of a linear perfluoropolyether compound having at least two alkenyl groups per molecule and having a perfluoropolyether structure containing a repeating unit —CₐF₂ₐO— in a main chain, “a” being an integer of 1 to 6;
(D) 0 to 60 parts by as of a polyfluoromonoalkenyl compound having one alkenyl group per molecule and having a perfluoropolyether structure in a main chain, a total amount of the components (A) and (D) being 100 parts by mass;
(B) an effective curing amount of an organosilicon compound having at least two silicon-bonded hydrogen atoms per molecule; and
(C) a catalytic amount of a hydrosilylation-reaction catalyst,

wherein a cured product of the curable perfluoropolyether adhesive composition is an adhesive having adhesion of less than 0.5 N/25 mm.

[3]

The curable perfluoropolyether adhesive composition according to [2], wherein the component (D) is a polyfluoromonoalkenyl compound represented by the following general formula (2):

Rf¹—(X′)ₚ—CH═CH₂ (2)

wherein X′ represents —CH₂—, —OCH₂—, —CH₂OCH₂—, or —CO—NR²—Y′—, Y′ is a group represented by —CH₂— or the following structural formula (Z′),

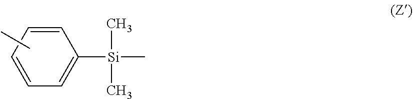

being a dimethylphenylsilylene group in an ortho-, meta-, or para-position, R² represents a hydrogen atom, a methyl group, a phenyl group, or an allyl group, “p” is 0 or 1, Rf¹ is a perfluoropolyether structure represented by a general formula F—[CF(CF₃)CF₂O]_{w}—CF(CF₃)—, and “w” represents an integer of 1 to 500.
[4]

The curable perfluoropolyether adhesive composition according to any one of [1] to [3], wherein the component (A) is a linear perfluoropolyether compound represented by the following general formula (1):

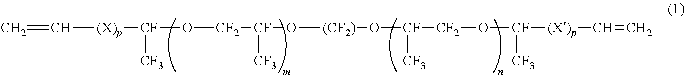

wherein X represents —CH₂—, —CH₂O—, —CH₂OCH₂—, or —Y—NR¹—CO—, Y is a group represented by —CH₂— or the following structural formula (Z), R¹ represents a hydrogen atom, a methyl group, a phenyl group, or an allyl group, X′ represents —CH₂—, —OCH₂—, —CH₂OCH₂—, or —CO—NR²—Y′—, Y′ is a group represented by —CH₂— or the following structural formula (Z′), R² represents a hydrogen atom, a methyl group, a phenyl group, or an allyl group, “p” is independently 0 or 1, “r” an integer of 2 to 6, “m” and “n” each represent an integer of 0 to 600, a sum of “m” and “n” further being 50 to 600,

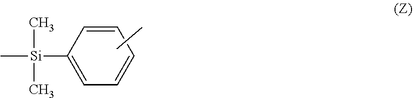

(Z) being a dimethylphenylsilylene group in an ortho-, meta-, or para-position, and

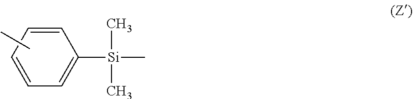

(Z′) being a dimethylphenyisilylene group in an ortho-, meta-, or para-position.
[5]

The curable perfluoropolyether adhesive composition according to [2] or [3], wherein the component (A) is a linear perfluoropolyether compound represented by the general formula (1),

the curable perfluoropolyether adhesive composition contains 0 to 20 parts by mass of the component (D) based on 100 to 80 parts by mass of the component (A), provided that a total of the component (A) and the component (D) is 100 parts by mass,

and the component (B) is a fluorine-containing organohydrogenpolysiloxane having a cyclic siloxane structure.

[6]

The curable perfluoropolyether adhesive composition according to [2] or [3], wherein the component is linear perfluoropolyether compound represented by the general formula (1),

the curable perfluoropolyether adhesive composition contains 21 to 45 parts by mass of the component (D) based on 79 to 55 parts by mass of the component (A), provided that a total of the component (A) and the component (D) is 100 parts by mass,

and the component (B) is a fluorine-containing organohydrogenpolysiloxane having a linear and/or branched siloxane structure.

[7]

The curable perfluoropolyether adhesive composition according to [2] or [3], wherein the component (A) is a linear perfluoropolyether compound containing a divalent perfluoropolyether structure including repeating units of a (CF₂O) unit and a (CF₂CF₂O) unit in a main chain,

the curable perfluoropolyether adhesive composition contains 0 to 50 parts by mass of the component (D) based on 100 to 50 parts by mass of the component (A), provided that a total of the component (A) and the component (D) is 100 parts by mass,

and the component (B) is a fluorine-containing organohydrogenpolysiloxane having a linear and/or branched siloxane structure.

[8]

The curable perfluoropolyether adhesive composition according to [2] or [3], wherein the component (A) is a linear perfluoropolyether compound represented by the general formula (1),

the linear perfluoropolyether compound containing a divalent perfluoropolyether structure including repeating units of a (CF₂O) unit and a (CF₂CF₂O) unit in a main chain,

the curable perfluoropolyether adhesive composition contains 0 to 50 parts by mass of the component (D) based on 100 to 50 parts by mass of the component (A), provided that a total of the component (A) and the component (D) is 100 parts by mass,

and the component (B) is a fluorine-containing organohydrogenpolysiloxane having a linear and/or branched siloxane structure.

[9]

The curable perfluoropolyether adhesive composition according to any one of [1] to [8], wherein the cured product of the curable perfluoropolyether adhesive composition is a non-conductive adhesive having a volume resistivity of 1×10⁹ Ω·cm or more.

[10]

An adhesive comprising the cured product of the curable perfluoropolyether adhesive composition according to any one of [1] to [9].

[11]

An adhesive tape comprising a cured layer of the curable perfluoropolyether adhesive composition according to any one of [1] to [9] provided on a substrate.

That is, a first embodiment of the present invention is a curable perfluoropolyether adhesive composition that gives a rubber-form cured product (cured perfluoropolyether rubber), the composition containing the following components (A) to (C):

(A) 100 parts by mass of a linear perfluoropolyether compound having at least two alkenyl groups per molecule and having a perfluoropolyether structure containing a repeating unit represented by —CₐF₂ₐO— in a main chain, “a” being an integer of 1 to 6;
(B) an effective curing amount of an organosilicon compound having at least two silicon-bonded hydrogen atoms per molecule; and
(C) a catalytic amount of a hydrosilylation-reaction catalyst,

where a cured product of the curable perfluoropolyether adhesive composition is an adhesive (cured perfluoropolyether rubber) having adhesion of less than 0.5 N/25 mm.

Hereinafter, the first embodiment of the present invention will be described in detail, but the present invention is not limited thereto.

### Component (A)

The component (A) contained in the inventive curable perfluoropolyether adhesive composition functions as a main ingredient (base polymer) of the inventive curable perfluoropolyether adhesive composition, and is a linear perfluoropolyether compound having at least two alkenyl groups per molecule and having a perfluoropolyether structure (perfluorooxyalkylene structure), preferably a divalent perfluorooxyalkylene structure in a main chain.

Here, examples of the perfluorooxyalkylene structure include those including a repeating structure of many oxyalkylene units shown by —CₐF₂ₐO— (in the formula, “a” in each unit independently represents an integer of 1 to 6), for example, those shown by the following general formula (5).

(CₐF₂ₐO)_{q} (5)

In the formula, “q” is an integer of 50 to 600, preferably an integer of 50 to 400, more preferably an integer of 50 to 200.

Examples of the individual repeating structures —CₐF₂ₐO— (i.e., oxyalkylene units) constituting the perfluorooxyalkylene structure shown by the formula (5) include the following structures and the like. Note that the perfluoroalkyl ether structure may be constituted by one kind of these repeating structures, or may be a combination of two or more kinds thereof.

—CF₂O—

—CF₂CF₂O—

—CF₂CF₂CF₂O—

—CF(CF₃)CF₂O—

—CF₂CF₂CF₂CF₂O—

CF₂CF₂CF₂CF₂CF₂CF₂O—

—C(CF₃)₂O—

Among these, the following structures are particularly suitable.

—CF₂O—

—CF₂CF₂O—

—CF₂CF₂CF₂O—

—CF(CF₃)CF₂O—

Note that in the present invention, “linear” indicates that the individual repeating units —CₐF₂ₐO— (oxyalkylene units) constituting the perfluoropolyether structure (perfluorooxyalkylene structure) of the main chain are bonded to one another linearly, and each of the repeating units (oxyalkylene units) themselves may be a linear oxyalkylene unit or a branched oxyalkylene unit (e.g., —CF(CF₃)CF₂O—, —C(CF₃)₂O—, etc.).

The component (A) is particularly preferably a linear perfluoropolyether compound containing a divalent perfluoropolyether structure including repeating units of a (CF₂O) unit and a (CF₂CF₂O) unit in a main chain.

As the alkenyl groups in the linear perfluoropolyether compound of the component (A), those having 2 to 8 carbon atoms, in particular, 2 to 6 carbon atoms, and having a CH₂═CH— structure on a terminal are preferable. For example, groups having a CH₂═CH— structure on a terminal such as a vinyl group, an allyl group, a propenyl group, an isopropenyl group, a butenyl group, and a hexenyl group are preferable, and a vinyl group, an allyl group, etc. are particularly preferable. These alkenyl groups may be bonded directly to both terminals of the perfluoropolyether structure, in particular, the divalent perfluorooxyalkylene structure constituting the main chain of the linear perfluoropolyether compound. Alternatively, the alkenyl groups may be bonded to the both terminals through a divalent linking group, for example, —CH₂—, —CH₂O—, —CH₂OCH₂—, or —Y—NR—CO—, provided that Y is a group represented by —CH₂— or the following structural formula (Z),

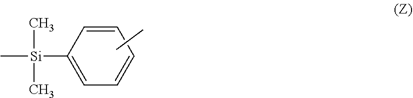

(Z) being a dimethylphenylsilylene group in an ortho-, meta-, or para-position, and
R represents a hydrogen atom, a methyl group, a phenyl group, or an allyl group. Furthermore, the component (A) has at least two alkenyl groups per molecule.

Examples of the component (A) include polyfluorodialkenyl compounds represented by the following general formula (6) or (7).

CH₂═CH—(X)ₚ—Rf²—(X′)ₚ—CH═CH₂ (6)

CH₂═CH—(X)ₚ—Q—Rf²—Q—(X′)ₚ—CH═CH₂ (7)

In the formulae, X independently represents —CH₂—, —CH₂O—, —CH₂OCH₂—, or —Y—NR¹—CO—, provided that Y is a group represented by —CH₂— or the following structural formula (Z) and R¹ represents a hydrogen atom, a methyl group, a phenyl group, or an allyl group. X′ represents —CH₂—, —OCH₂—, —CH₂OCH₂—, or —CO—NR²—Y′—, provided that Y′ is a group represented by —CH₂— or the following structural formula (Z′) and R² represents a hydrogen atom, a methyl group, a phenyl group, or an allyl group.

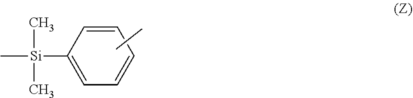

(Z) is a dimethylphenylsilylene group in an ortho-, meta-, or para-position.

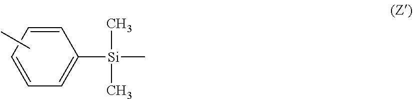

(Z′) is a dimethylsilylphenylene group in an ortho-, meta-, or para-position.

Rf² represents a divalent perfluoropolyether structure (perfluorooxyalkylene structure), and those represented by the formula (5), that is, (CₐF₂ₐO)_{q} are preferable. Q represents a divalent hydrocarbon group having 1 to 15 carbon atoms and may include an ether bond. Specific examples of Q are alkylene groups and alkylene groups that may include an ether bond. “p” independently represents 0 or 1.

Such a component (A) is particularly preferably a linear perfluoropolyether compound containing a divalent perfluoropolyether structure including repeating units of a (CF₂O) unit and a (CF₂CF₂O) unit in a main chain.

As such a component (A) linear perfluoropolyether compound, a compound shown by the following general formula (1) is particularly suitable.

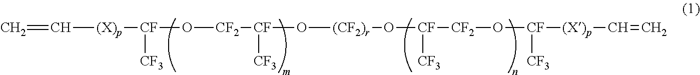

In the formula, X, X′, and “p” are as defined above. “r” is an integer of 2 to 6, “m” and “n” each represent an integer of 0 to 600, and furthermore, the sum of “m” and “n” is 50 to 600.

The linear perfluoropolyether compound of the general formula (1) desirably has a weight-average molecular weight of 3,000 to 100,000, particularly desirably 4,000 to 50,000 in molecular weight distribution measurement by gel permeation chromatography (GPC) analysis using a fluorine-based eluent as a developing solvent in terms of polyethylene. When the weight-average molecular weight is 4,000 or more, swelling of the compound in gasoline and other solvents is small. In particular, swelling in gasoline becomes 6% or lower, and the compound can meet the requirements of a material that requires gasoline resistance. Meanwhile, a weight-average molecular weight of 100,000 or less is practical since such a compound is not too viscous, and is excellent in workability. Note that the value of the degree of polymerization (m+n) of the linear perfluoropolyether compound of the general formula (1) can be similarly determined as a number-average polymerization degree, weight-average polymerization degree, or the like in molecular weight distribution measurement by gel permeation chromatography (GPC) analysis using a fluorine-based eluent as a developing solvent in terms of polyethylene. Note that the number-average polymerization degree and number-average molecular weight can also be calculated from the ratio of the terminal structures to the repeating unit structures obtained from a ¹⁹F-NMR spectrum.

Specific examples of the linear perfluoropolyether compound represented by the general formula (1) include those represented by the following formulae.

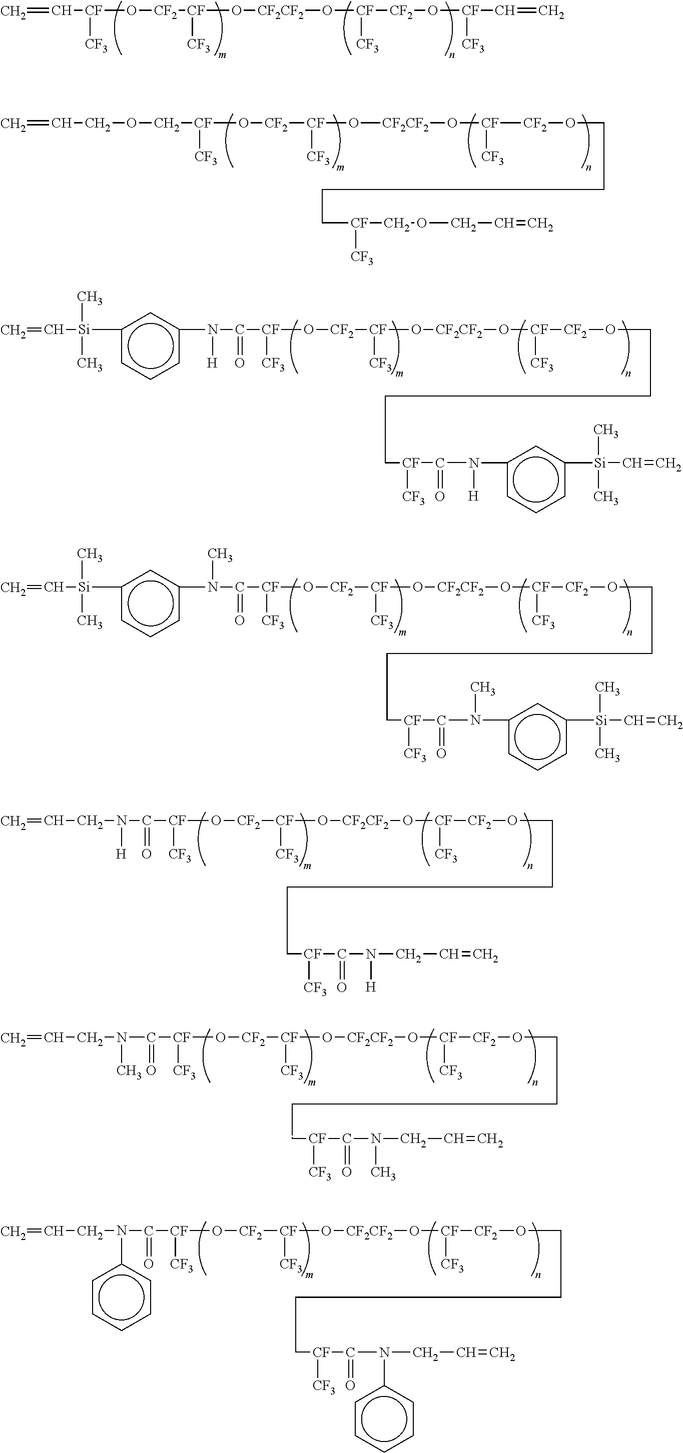

In the formulae, “m” and “n” each represent an integer of 0 to 600, preferably an integer of 0 to 200, and satisfy m+n=50 to 600, preferably m+n=50 to 200.

Furthermore, in the present invention, in order to adjust the linear perfluoropolyether compound of the formula (1) to have a desired weight-average molecular weight according to the purpose, it is also possible to subject the above-described linear perfluoropolyether compound to a hydrosilylation reaction beforehand with an organosilicon compound containing two SiH groups in a molecule according to an ordinary method and under ordinary conditions. The resulting chain-extended product can be used as the component (A). Incidentally, one kind of the component (A) linear perfluoropolyether compound may be used, or two or more kinds thereof may be used in combination.

### Component (B)

The component (B) serves as a crosslinking agent and/or chain extender for the component (A). The component (B) is an organosilicon compound such as an organohydrogenpolysiloxane having at least two, preferably three or more silicon-bonded hydrogen atoms (hydrosilyl groups represented by SiH) per molecule. Note that as the component (B) organosilicon compound, it is possible to use suitably a fluorine-containing organohydrogenpolysiloxane having one group or more groups of monovalent perfluoroalkyl groups, monovalent perfluorooxyalkyl groups, divalent perfluoroalkylene groups, and/or divalent perfluorooxyalkylene groups per molecule in view of compatibility with the component (A), or in the second embodiment of the present invention described below, compatibility with the component (A) and the component (D) described below, dispersibility, uniformity of the cured rubber product or cured gel product (adhesive), and so forth.

Examples of the component (B) include known organosilicon compounds disclosed in the Patent Document 1, Patent Document 2, and Patent Document 4, but are not particularly limited.

Examples of the monovalent or divalent fluorine-containing organic group include perfluoroalkyl groups, perfluorooxyalkyl groups, perfluoroalkylene groups, perfluorooxyalkylene groups, etc. represented by the following formulae.

C_{g}F_{2g+1}—

—C_{g}F_{2g}—

In the formulae, “g” is an integer of 1 to 20, preferably an integer of 2 to 10.

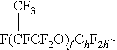

In the formula, “f” is an integer of 1 to 200, preferably an integer of 1 to 100, and “h” is an integer of 1 to 3.

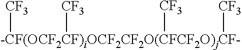

In the formula, “i” and “j” are each an integer of 1 or more, preferably an integer of 1 to 100, and the average of i+j is 2 to 200, preferably 2 to 100.

—(CF₂O)_{d}—(CF₂CF₂O)ₑ—CF₂—

In the formula, “d” and “e” are each an integer of 1 to 50, preferably an integer of 1 to 40.

Furthermore, these perfluoroalkyl groups, perfluorooxyalkyl groups, perfluoroalkylene groups, or perfluorooxyalkylene groups are preferably joined to a silicon atom via a divalent linking group. The divalent linking group may be an alkylene group, an arylene group, a combination thereof, or one of these groups having an intervening ether-bond oxygen atom, amide bond, carbonyl bond, ester bond, diorganosilylene group, or the like. Examples thereof include the following divalent linking groups having 2 to 12 carbon atoms etc., but are not limited thereto.

—CH₂CH₂—,

—CH₂CH₂CH₂—,

—CH₂CH₂CH₂OCH₂—,

—CH₂CH₂CH₂—NH—CO—,

—CH₂CH₂CH₂—N(Ph)—CO—,

—CH₂CH₂CH₂—N(CH₃)—CO—,

—CH₂CH₂CH₂—N(CH₂CH₃)—CO—,

—CH₂CH₂—Si(CH₃)₂—Ph′—N(CH₃)—CO—,

—CH₂CH₂CH₂—Si(CH₃)₂—Ph′—N(CH₃)—CO—,

—CH₂CH₂CH₂—O—CO—

In the formulae, Ph represents a phenyl group, and Ph′ represents a phenylene group.

Furthermore, examples of silicon-bonded monovalent substituents other than the monovalent or divalent fluorine-containing organic group and silicon-bonded hydrogen atoms the fluorine-containing organohydrogenpolysiloxane of the component (B) include alkyl groups such as a methyl group, an ethyl group, a propyl group, a butyl group, a hexyl group, a cyclohexyl group, an octyl group, and a decyl group; alkenyl groups such as a vinyl group and an allyl group; aryl groups such as a phenyl group, a tolyl group, and a naphthyl group; aralkyl groups such as a benzyl group and a phenylethyl group; and such groups having some or all the hydrogen atoms thereof substituted with a chlorine atom, a cyano group, etc., for example, an unsubstituted or substituted monovalent hydrocarbon group having 1 to 20, preferably 1 to 12 carbon atoms such as a chloromethyl group, a chloropropyl group, and a cyanoethyl group.

The siloxane structure in the component (B) fluorine-containing organohydrogenpolysiloxane may be cyclic, linear, branched, three-dimensional network, or a combination thereof. The number of silicon atoms in the fluorine-containing organohydrogenpolysiloxane is not particularly restricted, but is usually 2 to 60, preferably about 3 to 30. As the component (B) fluorine-containing organohydrogenpolysiloxane, a fluorine-containing organohydrogenpolysiloxane having a cyclic structure containing a monovalent perfluoroalkyl group or a monovalent perfluorooxyalkyl group; or a fluorine-containing organohydrogenpolysiloxane having a branched or cyclic organohydrogenpolysiloxane structure on both terminals of a divalent perfluoroalkylene group or a divalent perfluorooxyalkylene group is particularly preferable.

Examples of such a component (B) having a monovalent or divalent fluorine-containing organic group and silicon-bonded hydrogen atoms include the following compounds. One kind of these compounds may be used, or two or more kinds thereof may be used in combination. Note that in the following formulae, Me represents a methyl group, and Ph represents a phenyl group.

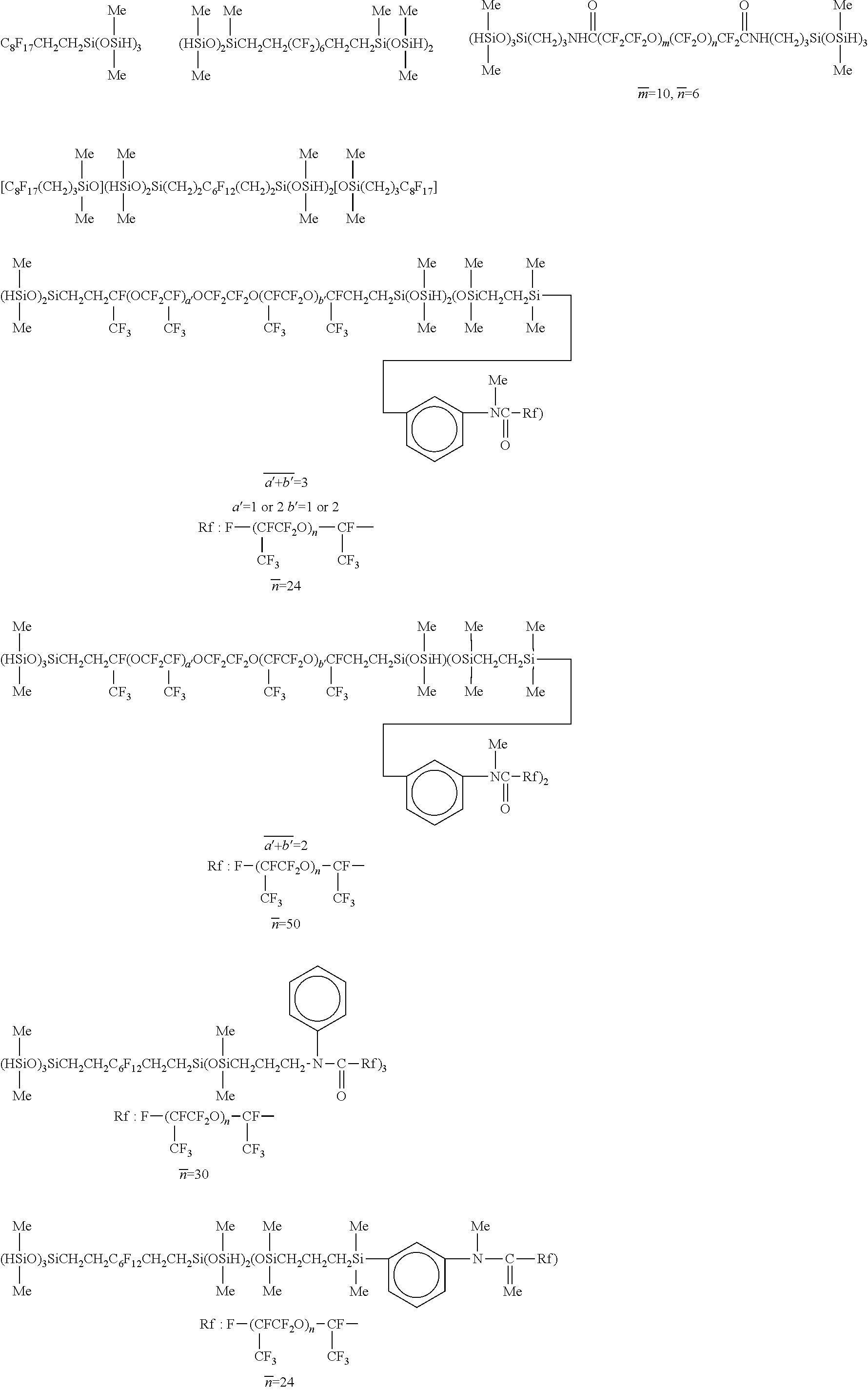

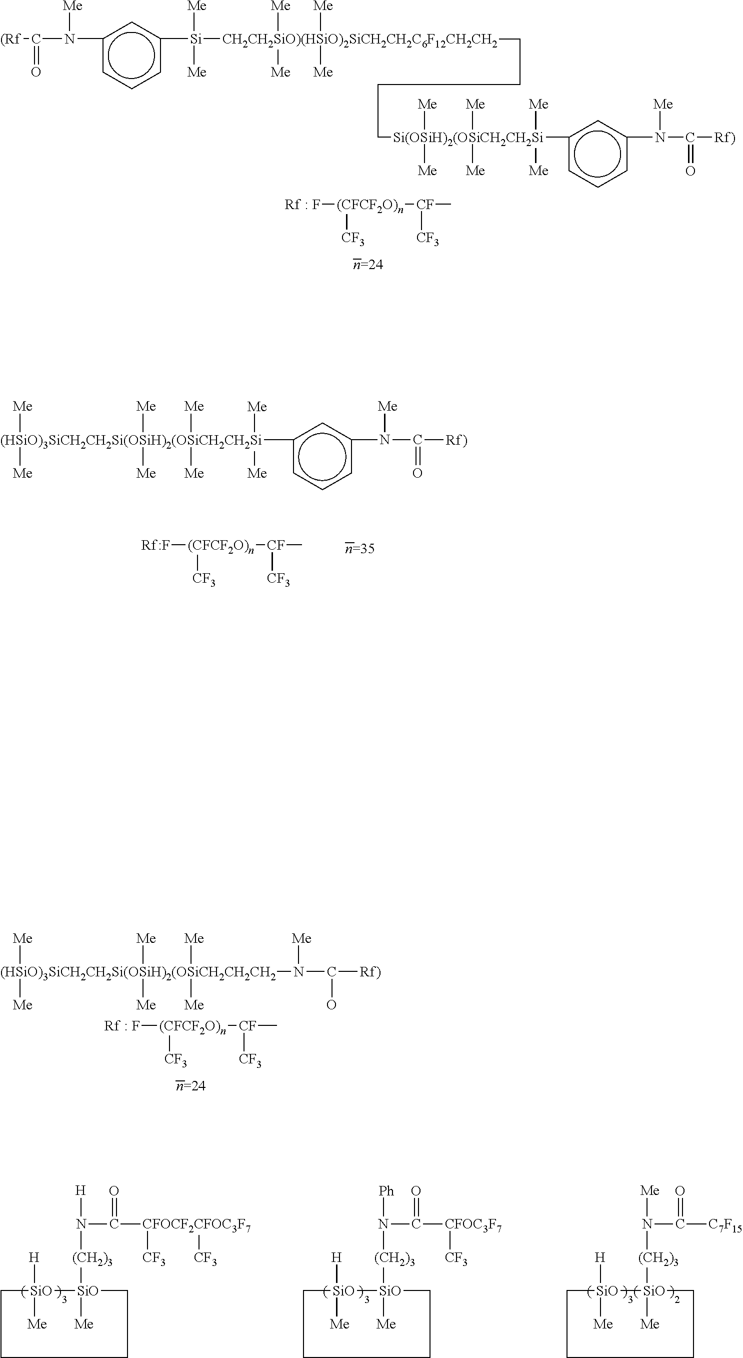

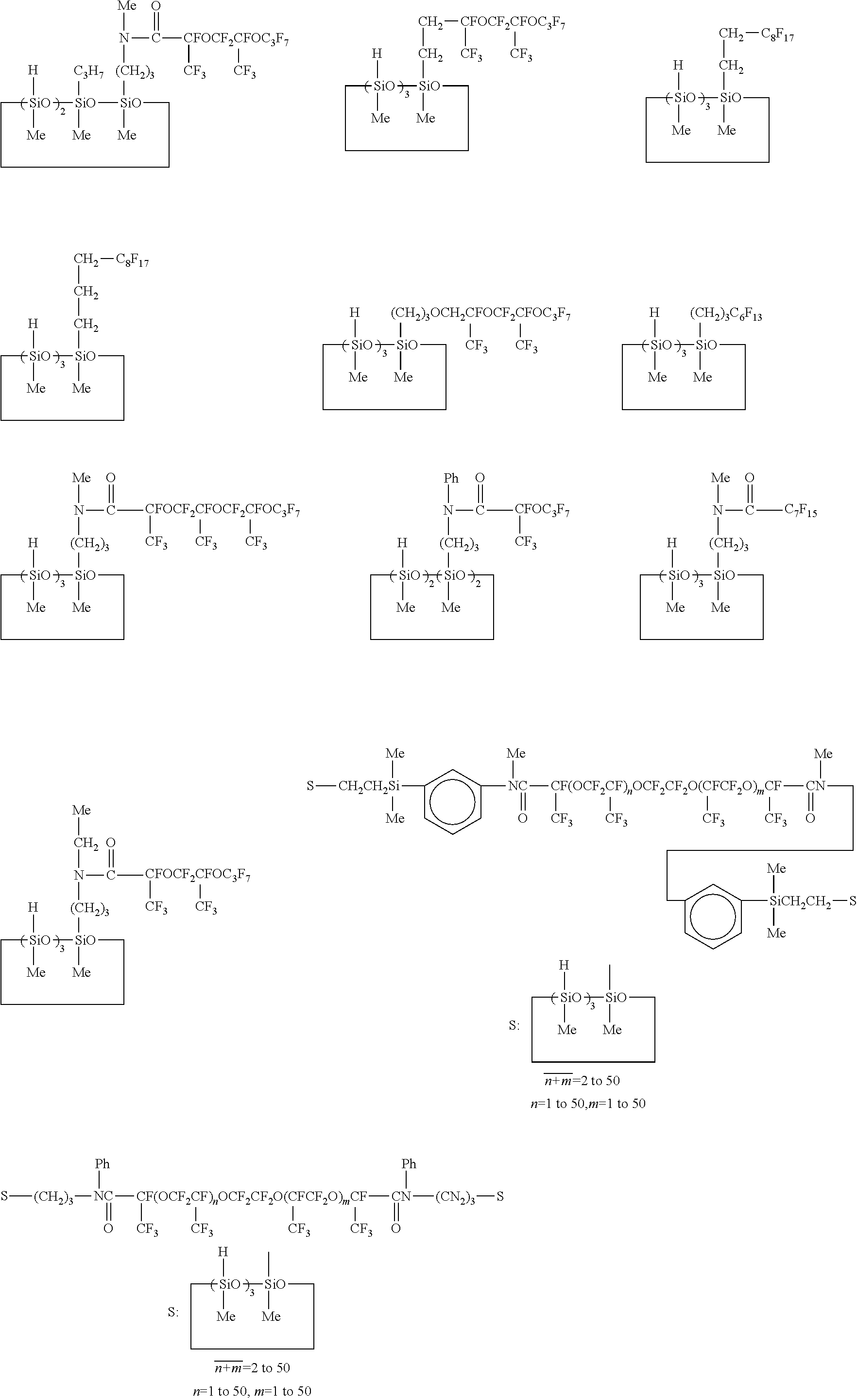

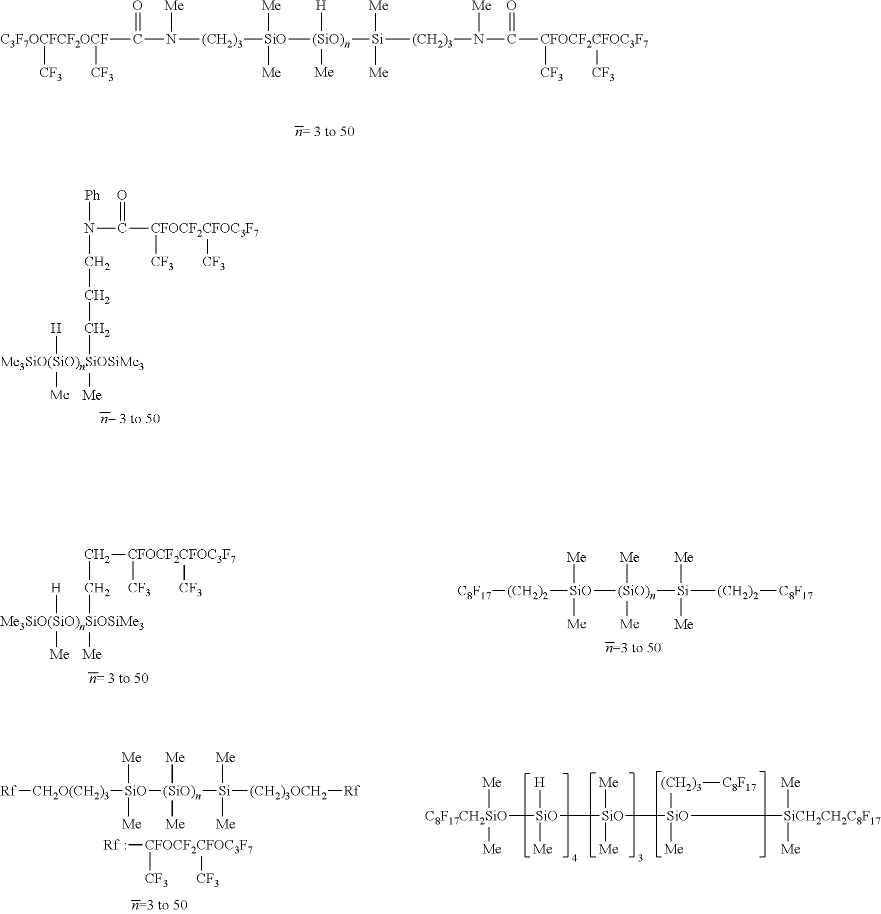

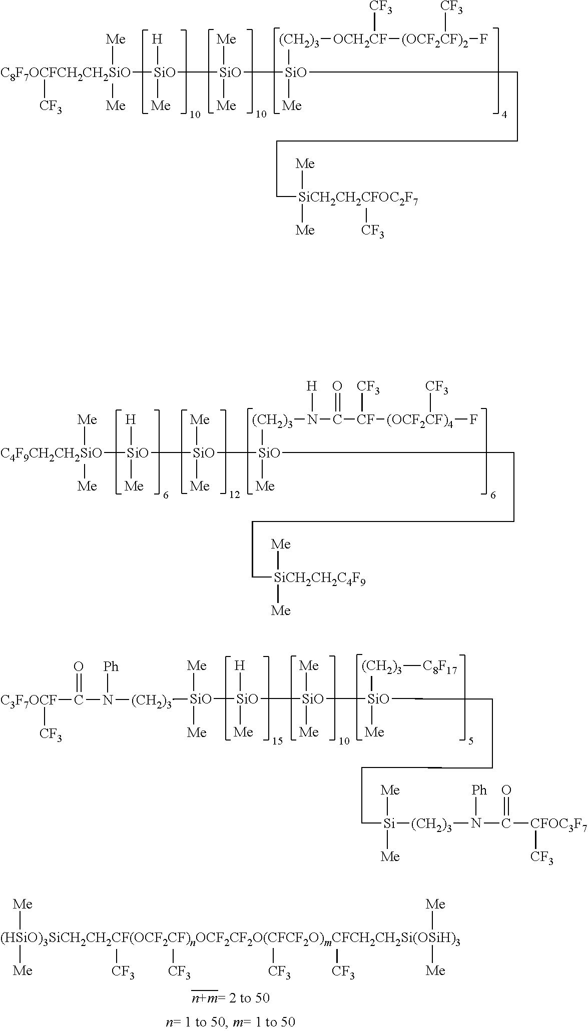

The blended amount of the component (B) is an effective amount for curing the component (A) and the component (D) described below, that is, an effective curing amount. In particular, the blended amount is an amount at which there is preferably 0.2 to 4 mol, more preferably 0.5 to 3 mol of the hydrosilyl groups (Si—H) in the component based on 1 mol of the alkenyl groups contained in the component (A), or in the second embodiment of the present invention described below, based on a total of 1 mol of the alkenyl groups contained in the component (A) and component (D) in the present composition. When the amount of the hydrosilyl groups (Si—H) is 0.2 mol or more, the degree of crosslinking is sufficient, and there is no risk that a cured product cannot be obtained. Meanwhile, when the amount of the hydrosilyl groups (Si—H) is 4 mol or less, there is no risk of foaming during curing.

One kind of the component (B) can be used, or a combination of two or more kinds thereof can be used.

### Component (C)

The component (C) hydrosilylation-reaction catalyst (addition-reaction catalyst) of the present invention is a catalyst that promotes an addition reaction between the hydrosilyl groups in the component (B) and the alkenyl groups in the component (A), or in the second embodiment of the present invention described below, the alkenyl groups in the component (A) and the component (E) described below. This hydrosilylation-reaction catalyst is generally a noble metal (platinum group metal) compound, which is expensive, and therefore, platinum or a platinum compound, which are relatively readily available, are often used.

Examples of the platinum compound include chloroplatinic acid, complexes of chloroplatinic acid with olefins such as ethylene, complexes of chloroplatinic acid with alcohols or vinylsiloxanes, and metallic platinum supported on silica, alumina, carbon, or the like. Known platinum group metal catalysts other than the platinum compounds include rhodium-, ruthenium-, iridium-, and palladium-based compounds. Examples thereof include RhCl(PPh₃)₃, RhCl(CO)(PPh₃)₂, Ru₃(CO)₁₂, IrCl(CO)(PPh₃)₂, Pd(PPh₃)₄, etc.

The blended amount of the hydrosilylation-reaction catalyst can be a catalytic amount. Usually, the hydrosilylation-reaction catalyst is preferably contained in an amount of 0.1 to 500 ppm (in terms of the mass of the platinum group metal), more preferably 0.1 to 100 ppm based on the total mass of the components (A), (B), and (D). One kind of the component (C) hydrosilylation-reaction catalyst can be used, or a combination of two or more kinds thereof can be used.

### Other Components

Besides the components (A) to (C), the inventive composition may optionally contain various additives. Examples of regulators for hydrosilylation-reaction catalyst include acetylenic alcohols such as 1-ethynyl-1-hydroxycyclohexane, 3-methyl-1-butyn-3-ol, 3,5-dimethyl-1-hexyn-3-ol, 3-methyl-1-penten-3-ol, and phenylbutynol; 3-methyl-3-penten-1-yne and 3,5-dimethyl-3-hexen-1-yne; polymethylvinylsiloxane cyclic compounds; and organophosphorus compounds. When such a regulator is contained, appropriate curing reactivity and storage stability can be maintained.

In addition, to impart adhesiveness, known tackifiers containing an epoxy group, an alkoxy group, or the like may also be contained. Examples of the tackifiers include adhesive-functional-group-containing hydrolyzable organosilane compounds having an epoxy group and a trialkoxysilyl group in a molecule (so-called epoxy group-containing silane coupling agents), (fluorine-containing) organohydrogenpolysiloxanes necessarily containing a silicon-bonded hydrogen atom (SiH group) in a molecule and further containing an epoxy group bonded to a silicon atom via a carbon atom or a carbon atom and an oxygen atom, (fluorine-containing) organohydrogenpolysiloxanes necessarily containing a silicon-bonded hydrogen atom (SiH group) in a molecule and further containing a trialkoxysilyl group bonded to a silicon atom via a carbon atom or a carbon atom and an oxygen atom, (fluorine-containing) organohydrogenpolysiloxanes necessarily containing a silicon-bonded hydrogen atom (SiH group) in a molecule, further containing an epoxy group bonded to a silicon atom via a carbon atom or a carbon atom and an oxygen atom, and containing a trialkoxysilyl group bonded to a silicon atom via a carbon atom or a carbon atom and an oxygen atom, etc.

In addition, the second embodiment of the present invention provides a curable perfluoropolyether adhesive composition that gives a rubber-form cured product (cured perfluoropolyether rubber) or a gel-form cured product (cured perfluoropolyether gel), the composition containing the following components (A) to (D):

(A) 100 to 40 parts by mass of a linear perfluoropolyether compound having at least two alkenyl groups per molecule and having a perfluoropolyether structure containing a repeating unit —CₐF₂ₐO— in a main chain, “a” being a integer of 1 to 6;
(D) 0 to 60 parts by mass of a polyfluoromonoalkenyl compound having one alkenyl group per molecule and having a perfluoropolyether structure in a main chain, a total amount of the components (A) and (D) being 100 parts by mass;
(B) an effective curing amount of an organosilicon compound having at least two silicon-bonded hydrogen atoms per molecule; and
(C) a catalytic amount of a hydrosilylation-reaction catalyst,

where a cured product of the curable perfluoropolyether adhesive composition is an adhesive (cured perfluoropolyether rubber or cured perfluoropolyether gel) having adhesion of less than 0.5 N/25 mm.

As the components (A) to (C) in this event, the same components as those described above can be used.

Note that the curable perfluoropolyether adhesive composition of the second embodiment of the present invention contains the component (D) in an amount of 0 to 60 parts by mass. Therefore, the composition of the second embodiment of the present invention may or may not contain the component (D). That is, in the composition of the second embodiment of the present invention, the component (D) is an optional component. When the component of the second embodiment of the present invention contains a predetermined amount of the component (D), the composition gives a gel-form cured product (cured perfluoropolyether gel). Meanwhile, since the components (A) to (C) in the composition of the second embodiment of the present invention are the components (A) to (C) in the composition of the first embodiment described above, the composition of the second embodiment of the present invention in which the component (D) is not contained can be the curable perfluoropolyether adhesive composition of the first embodiment described above that gives a rubber-form cured product. In other words, the curable perfluoropolyether adhesive composition of the second embodiment of the present invention encompasses the curable perfluoropolyether adhesive composition of the first embodiment of the present invention. The curable perfluoropolyether adhesive composition of the second embodiment of the present invention preferably contains 100 to 55 parts by mass of the component (A) and 0 to 45 parts by mass of the component (D) (provided that the total amount of the components (A) and (D) is 100 parts by mass).

### Component (D)

The component (D) is a component that is used in a specific second embodiment (i.e., the composition that gives a cured rubber or a cured gel) as opposed to the above-described first embodiment of the present invention (i.e., the composition that gives the cured rubber) in the inventive curable perfluoropolyether adhesive composition. The component (D) is a polyfluoromonoalkenyl compound having one alkenyl group per molecule and having a perfluoropolyether structure in a main chain. In particular, a polyfluoromonoalkenyl compound of the following formula (2) is preferable.

Rf¹—(X′)ₚ—CH═CH₂ (2)

In the formula, X′ and “p” are as described above, and Rf¹ is shown by the following general formula.

F—[CF(CF₃)CF₂O]_{w}—CF(CF₃)—

In the formula, “w” represents an integer of 1 to 500, preferably an integer of 2 to 200.

Specific examples of the polyfluoromonoalkenyl compound represented by the general formula (2) include the following.

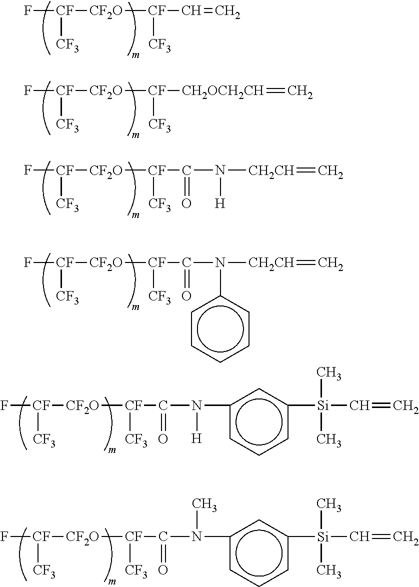

In the formulae, “m” is an integer of 1 to 200, in particular, an integer of 2 to 100.

When the polyfluoromonoalkenyl compound of the formula (2) is blended, the amount to be blended is selected so that in the curable perfluoropolyether adhesive composition, the proportion of the component (A) linear perfluoropolyether dialkenyl compound to the component (D) in the composition is: 100 to 40 parts by mass or the component (A) to 0 to 60 parts by mass of the component (D), where the total amount of the component (A) and the component (D) is 100 parts by mass.

For example, the perfluoropolyether adhesive composition of the second embodiment of the present invention can contain the component (D) so that the proportion of the component (D) is 20 to 60 parts by mass relative to 80 to 40 parts by mass of the component (A), and so that the total amount of the component (A) and the component (D) is 100 parts by mass. Note that one kind of the component (D) polyfluoromonoalkenyl compound may be used, or two or more kinds thereof may be used in combination.

### Other Components

In the present composition, various additives such as various tackifiers similar to those described above can be optionally contained besides the components (A) to (D) in the same manner as in the first embodiment. Examples of regulators for hydrosilylation-reaction catalyst include the same compounds as those described above.

### Cured Product

The inventive perfluoropolyether adhesive composition forms an adhesive including cured perfluoropolyether rubber or cured perfluoropolyether gel having adhesion (low surface adhesion) of less than 0.5 N/25 mm, preferably 0.001 to 0.45 N/25 mm, more preferably 0.002 to 0.4 N/25 mm by curing the above-described composition. The inventive perfluoropolyether adhesive composition can form a cured product (an adhesive) excellent in heat resistance, water repellency, oil repellency, weatherability, and so forth, and moreover, particularly excellent in chemical resistance and solvent resistance, that can be used for various purposes.

Note that regarding the cured product obtained by curing the inventive perfluoropolyether adhesive composition, it is preferable to use a perfluoropolyether adhesive composition that satisfies the following conditions or the like in order to obtain a rubber- or gel-form cured product having surface adhesion of less than 0.5 N/25 mm. When a linear perfluoropolyether compound represented by the general formula is used as the component (A),

(i) in a composition containing a combination of 0 to 20 parts by mass of the component (D) with 100 to 80 parts by mass of the component (A) (the total of the component (A) and the component (D) being 100 parts by mass), use, as the component (B) crosslinking agent, a fluorine-containing organohydrogenpolysiloxane having a cyclic siloxane structure, or
(ii) in a composition containing a combination of 21 to 45 parts by mass of the component (D) with 79 to 55 parts by mass of the component (A) (the total of the component (A) and the component (D) being 100 parts by mass), use, as the component (B) crosslinking agent, a fluorine-containing polyorganohydrogensiloxane having a linear and/or branched siloxane structure. Alternatively, when. a polyfluorodialkenyl compound represented by the general formula (6) or (7) is contained as the component (A), the polyfluorodialkenyl compound being a linear perfluoropolyether compound containing repeating units of a (CF₂O) unit and a (CF₂CF₂O) unit as the divalent perfluolopolyether Rf² constituting the main chain,
(iii) in a composition containing a combination of 0 to 50 parts by mass of the component (D) with 100 to 50 parts by mass of the component (the total of the component (A) and the component (D) being 100 parts by mass), use, as the component (B) crosslinking agent, a fluorine-containing organohydrogenpolysiloxane having a linear and/or branched siloxane structure.

For example, in the first embodiment of the present invention, the perfluoropolyether adhesive composition can be cured and formed by using, based on 100 parts by mass of the component (A), the component (B) in such an amount that 0.2 to 3.0 mol of the hydrosilyl groups in the component (B) is contained based on 1 mol of the total of the alkenyl groups contained in the component (A), and 0.1 to 100 ppm of the component (C) based on a total amount of the components (A) and (B) in terms of platinum.

In addition, for example, in the second embodiment of the present invention, the perfluoropolyether adhesive composition can be cured and formed by using, based on 100 to 40 parts by mass of the component (A), 0 to 60 parts by mass of the component (D) provided that the total of the components (A) and (D) is 100 parts by mass, the component (B) in such an amount that 0.2 to 3.0 mol of the hydrosilyl groups in the component (B) is contained based on 1 mol of the total of the alkenyl groups contained in the components (A) and (D), and 0.1 to 100 ppm of the component (C) based on a total amount of the components (A), (B), and (D) in terms of platinum.

The formation of the perfluoropolyether adhesive composition is performed by coating an appropriate substrate with one of the inventive compositions and then curing the composition, or by a conventionally known method by bonding or the like. Curing can be performed easily, usually by a heat treatment at a temperature of 60 to 150° C. and of about 1 to 30 minutes.

The inventive adhesive containing the inventive perfluoropolyether adhesive composition can be used, for example, for automobiles, chemical plants, semiconductor manufacturing lines, analytical or scientific instruments, medical equipment, aircraft, and optical components.

Furthermore, for example, an adhesive tape obtained by providing a cured product (cured perfluoropolyether rubber or cured perfluoropolyether gel) layer of the inventive curable perfluoropolyether adhesive composition on a substrate formed from an organic resin film such as a polyethylene terephthalate (PET) film is excellent in heat resistance, oil resistance, low-temperature properties, moisture resistance, low gas permeability, and so forth, and is particularly useful as an adhesive tape having a non-conductive adhesive layer excellent in chemical resistance and solvent resistance.

When the inventive adhesive composition is applied, it is advantageous to use a known primer in order to improve the bond or adhesion of the inventive adhesive composition to the substrate. The use of a primer prevents penetration of chemicals and solvents from the substrate interface, and improves the acid resistance, chemical resistance, and solvent resistance of entire parts.

As the primer, use may be made of silane-based primers based on silane coupling agents, organohydrogenpolysiloxane-based primers, synthetic rubber-based primers, acrylic resin-based primers, urethane resin-based primers, and epoxy resin-based primers. The perfluoropolyether rubber composition of the present invention having a tackifier added thereto is also useful as the primer.

Furthermore, the cured product (cured perfluoropolyether rubber or cured perfluoropolyether gel) of the inventive curable perfluoropolyether adhesive composition is preferably a non-conductive adhesive having a volume resistivity of 1×10⁹ Ω·cm or more. Such a curable perfluoropolyether adhesive composition of the present invention is suitable as a material for a non-conductive adhesive. The upper limit of the volume resistivity of the cured product of the inventive curable perfluoropolyether adhesive composition is not particularly limited, but can be, for example, 1×10¹³ Ω·cm.

Such a perfluoropolyether adhesive composition or the present invention is excellent in heat resistance, weatherability, oil resistance, low-temperature properties, moisture resistance, low gas permeability, water repellency, oil repellency, etc., is particularly excellent in chemical resistance and solvent resistance, and provides a low-adhesion cured product (adhesive). An adhesive tape including a cured product having low adhesion can be peeled off without damaging a substrate even when bonded to a fragile substrate.

In addition, a third embodiment of the present invention is the adhesive including the cured product (cured perfluoropolyether rubber or cured perfluoropolyether gel) of the inventive curable perfluoropolyether adhesive composition described above.

As described above, the inventive perfluoropolyether adhesive composition can give a cured product (adhesive) excellent in heat resistance, weatherability, oil resistance, chemical resistance, solvent resistance, low-temperature properties, moisture resistance, low gas permeability, water repellency, oil repellency, and so forth. Accordingly, the inventive adhesive is excellent in heat resistance, weatherability, oil resistance, chemical resistance, solvent resistance, low-temperature properties, moisture resistance, low gas permeability, water repellency, oil repellency, etc. Moreover, the cured product contained in the inventive adhesive has low adhesion. Therefore, an adhesive tape including the inventive adhesive can be peeled from a substrate without damaging the substrate even when bonded to a fragile substrate.

Furthermore, a fourth embodiment of the present invention is the adhesive tape described above, including a provided cured layer of the inventive curable perfluoropolyether adhesive composition.

As described above, the inventive perfluoropolyether adhesive composition can provide a cured product (adhesive) excellent in heat resistance, weatherability, oil resistance, chemical resistance, solvent resistance, low-temperature properties, moisture resistance, low gas permeability, water repellency, oil repellency, and so forth. Accordingly, the inventive adhesive tape is excellent in heat resistance, weatherability, oil resistance, chemical resistance, solvent resistance, low-temperature properties, moisture resistance, low gas permeability, water repellency, oil repellency, etc. Moreover, the cured product contained in the inventive adhesive tape has low adhesion. Therefore, the inventive adhesive tape can be peeled from a substrate without damaging the substrate even when bonded to a fragile substrate.

### EXAMPLE

Hereinafter, the present invention will be described specifically with reference no Examples and Comparative Examples, but the present invention is not restricted to the following Examples. Note that in the following examples, “%” indicates “mass %”.

### Examples 1 to 9 and Comparative Examples 1 to 3

Using the following ingredients, the curable perfluoropolyether adhesive compositions shown in Table 1 were prepared. These adhesive compositions were cured under curing conditions of 130° C. and 5 minutes. The surface adhesion of each cured product was measured, and in addition, a solvent resistance test was performed according to the method described below. The results are shown together in Table 1.

### Ingredients

(A) Linear perfluoropolyether compound
(A-1) Difunctional perfluoropolyether (perfluoropolyether 1)

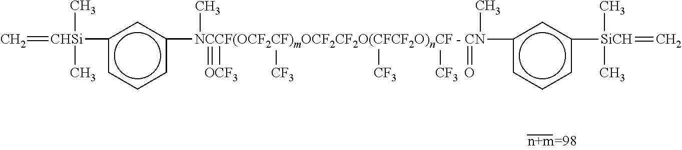

(A-2) Difunctional perfluoropolyether (perfluoropolyether 2)

CH₂═CH—CH₂—O—CH₂Rf—CH₂—O—CH₂—CH═CH₂

(Rf: —CF₂O(CF₂CF₂O)_{20.8}(CF₂O)_{22.1}CF₂—)

Here, the arrangement of the repeating units CF₂CF₂O and CF₂O is random
(D) Monofunctional perfluoropolyether compound (perfluoropolyether 3)

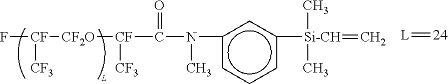

### (B) Organohydrogenpolysiloxane

(b-1) Organohydrogensiloxane 1

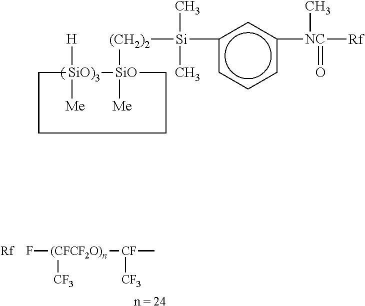

(b-2) Oragnohydrogensiloxane 2

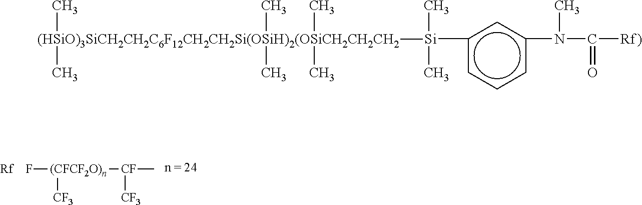

(C) Solution of platinum-divinyltetramethyldisiloxane complex in ethanol (platinum content: 3.0%)
(e) Curing regulator: 50% solution of ethynyl cyclohexanol in toluene
(f) KR-3700 (trade name, manufactured by Shin-Etsu Chemical Co., Ltd.) addition-curable silicone adhesive based on dimethylsilicone

### Adhesion Measurement

The compositions of the Examples and Comparative Examples were respectively applied to a 50-μm thick and 25-mm wide PET (polyethylene terephthalate) film by using an applicator so as to have a thickness of 30 μm. Subsequently, each composition was cured to a rubber or gel form by heating under conditions of 130° C. and 5 minutes. Thus, adhesive tapes each having a 30-μm thick adhesive layer (cured rubber layer or cured gel layer) provided on a 50-μm thick PET film were fabricated. Each of these adhesive tapes was bonded to a metal plate (polished stainless steel plate). A roller having a weight of 2 kg and covered with a rubber layer was moved back and forth over the tape substrate once to press the adhesive tape on. The adhesive tape was left to stand at room temperature for 20 hours. Then, at 25° C., the force (N/25 mm) required to peel the adhesive tape away from the stainless steel plate at a tensile rate of 300 mm/minute at an angle of 180° was measured as the adhesion of each adhesive layer (cured rubber layer or cured gel layer) by using a tensile testing machine.

### Solvent Resistance Test (Weight Change)

3 g of the compositions of the Examples and Comparative Examples were respectively charged into a ϕ×15 mm glass container. Then, each composition was cured under the conditions of 130° C. and 5 minutes to produce a sample. Each sample was immersed in xylene and Fuel C (a 50/50 (wt %) mixed solution of toluene/isooctane) at 25° C. for 7 days, and the weight change rate of before and after the immersion was measured.

TABLE 1

| | | | | | | | | | | | Comparative | | |
|---|---|---|---|---|---|---|---|---|---|---|---|---|---|
| Component | | Example | | | | | | | | | Example | | |
| (parts by mass) | | 1 | 2 | 3 | 4 | 5 | 6 | 7 | 8 | 9 | 1 | 2 | 3 |
| A-1 | Perfluoropolyether 1 | 100 | 95.1 | 90.7 | 86.6 | 95.1 | 86.6 | 73.5 | 68.3 | — | — | 95.1 | 95.1 |
| A-2 | Perfluoropolyether 2 | — | — | — | — | — | — | — | — | 100 | — | — | — |
| D | Perfluoropolyether 3 | — | 4.9 | 9.3 | 13.4 | 4.9 | 13.4 | 26.5 | 31.7 | — | — | 4.9 | 4.9 |
| b-1 | Organohydrogensiloxane 1 | 20.2 | 21.1 | 21.9 | 22.8 | — | — | — | — | — | — | — | 21.1 |
| b-2 | Organohydrogensiloxane 2 | — | — | — | — | 19.0 | 20.5 | 22.8 | 23.7 | 74.7 | — | — | — |
| C | Platinum compound | 0.02 | 0.02 | 0.02 | 0.02 | 0.02 | 0.02 | 0.02 | 0.02 | 0.02 | — | 0.02 | — |
| e | Curing regulator | 0.03 | 0.03 | 0.03 | 0.03 | 0.03 | 0.03 | 0.03 | 0.03 | 0.03 | — | 0.03 | 0.03 |
| f | KR-3700 | — | — | — | — | — | — | — | — | — | 100 | — | — |

| | | | | | | | | | | | | |
|---|---|---|---|---|---|---|---|---|---|---|---|---|
| Adhesion (N/25 mm) | 0.11 | 0.09 | 0.12 | 0.25 | 0.05 | 0.09 | 0.11 | 0.34 | 0.03 | 12.1 | Not | Not |
| | | | | | | | | | | | cured | cured |
| Solvest resistance (%) Xylene | 1.5 | 1.7 | 1.0 | 2.0 | 1.5 | 1.7 | 2.2 | 2.5 | 1.2 | 181 | | |
| Solvent resistance (%) Fuel C | 1.3 | 1.3 | 1.4 | 1.8 | 1.1 | 1.2 | 2.1 | 2.4 | 1.0 | 219 | | |

As shown in Table 1, the adhesives in Examples 1 to 9, using the inventive curable perfluoropolyether adhesive compositions had high solvent resistance. On the contrary, the silicone adhesive in Comparative Example 1 had excessively high adhesion, and also had low solvent resistance. Meanwhile, in Comparative Example 2 and Comparative Example 3, in which the essential composition of the present invention component (B) or component (C) was not contained, the compositions were not cured.

From the above, it has been shown that the present invention can achieve a low-adhesion curable perfluoropolyether adhesive composition that gives a cured product (adhesive) excellent in heat resistance, weatherability, water repellency, oil repellency, and so forth, and moreover, particularly excellent in chemical resistance and solvent resistance.

It should be noted that the present invention is not limited to the above-described embodiments. The embodiments are just examples, and any examples that have substantially the same feature and demonstrate the same functions and effects as those in the technical concept disclosed in claims of the present invention are included in the technical scope of the present invention.

1-11. (canceled)

12. A curable perfluoropolyether adhesive composition comprising the following components (A) to (C):
(A) 100 parts by mass of a linear perfluoropolyether compound having at least two alkenyl groups per molecule and having a perfluoropolyether structure containing a repeating unit represented by —CₐF₂ₐO— in a main chain, “a” being an integer of 1 to 6;
(B) an effective curing amount of an organosilicon compound having at least two silicon-bonded hydrogen atoms per molecule; and
(C) a catalytic amount of a hydrosilylation-reaction catalyst,
wherein a cured product of the curable perfluoropolyether adhesive composition is an adhesive having adhesion of less than 0.5 N/25 mm.

13. A curable perfluoropolyether adhesive composition comprising the following components (A) to (D):
(A) 100 to 40 parts by mass of a linear perfluoropolyether compound having at least two alkenyl groups per molecule and having a perfluoropolyether structure containing a repeating unit —CₐF₂ₐO— in a main chain, “a” being an integer of 1 to 6;
(D) 0 to 60 parts by mass of a polyfluoromonoalkenyl compound having one alkenyl group per molecule and having a perfluoropolyether structure in a main chain, a total amount of the components (A) and (D) being 100 parts by mass;
(B) an effective curing amount of an organosilicon compound having at least two silicon-bonded hydrogen atoms per molecule; and
(C) a catalytic amount of a hydrosilylation-reaction catalyst,
wherein a cured product of the curable perfluoropolyether adhesive composition is an adhesive having adhesion of less than 0.5 N/25 mm.

14. The curable perfluoropolyether adhesive composition according to claim 13, wherein the component (D) is a polyfluoromonoalkenyl compound represented by the following general formula (2):
Rf¹—(X′)ₚ—CH═CH₂ (2)
wherein X′ represents —CH₂—, —OCH₂—, —CH₂OCH₂—, or —CO—NR²—Y′—, Y′ is a group represented by —CH₂— or the following structural formula (Z′), 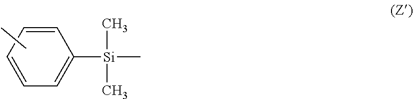
being a dimethylphenylsilylene group in an ortho-, meta-, or para-position, R² represents a hydrogen atom, a methyl group, a phenyl group, or an allyl group, “p” is 0 or 1, Rf¹ is a perfluoropolyether structure represented by a general formula F—[CF(CF₃)CF₂O]_{w}—CF(CF₃)—, and “w” represents an integer of 1 to 500.

15. The curable perfluoropolyether adhesive composition according to claim 12, wherein the component (A) is a linear perfluoropolyether compound represented by the following general formula (1): 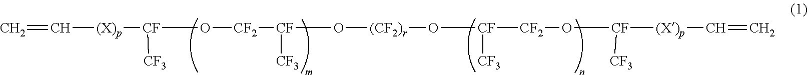
wherein X represents —CH₂—, —CH₂O—, —CH₂OCH₂—, or —Y—NR¹—CO—, Y is a group represented by —CH₂— or the following structural formula (Z), R¹ represents a hydrogen atom, a methyl group, a phenyl group, or an allyl group, X′ represents —CH₂—, —OCH₂—, —CH₂OCH₂—, or —CO—NR²—Y′—, Y′ is a group represented by —CH₂— or the following structural formula (Z′), R² represents a hydrogen atom, a methyl group, a phenyl group, or an allyl group, “p” is independently 0 or 1, “r” is an integer of 2 to 6, “m” and “n” each represent an integer of 0 to 600, a sum of “m” and “n” further being 50 to 600, 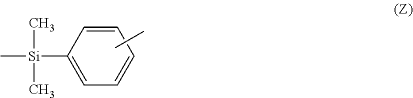
(Z) being a dimethylphenylsilylene group in an ortho-, meta-, or para-position, and 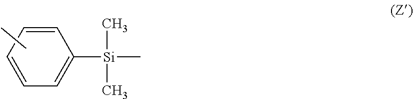
(Z′) being a dimethylphenylsilylene group in an ortho-, meta-, or para-position.

16. The curable perfluoropolyether adhesive composition according to claim 13, wherein the component (A) is a linear perfluoropolyether compound represented by the following general formula (1): 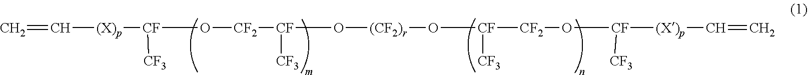
wherein X represents —CH₂—, —CH₂O—, —CH₂OCH₂—, or —Y—NR¹—CO—, Y is a group represented by —CH₂— or the following structural formula (Z), R¹ represents a hydrogen atom, a methyl group, a phenyl group, or an allyl group, X′ represents —CH₂—, —OCH₂—, —CH₂OCH₂—, or —CO—NR²—Y′—, Y′ is a group represented by —CH₂— or the following structural formula (Z′), R² represents a hydrogen atom, a methyl group, a phenyl group, or an allyl group, “p” is independently 0 or 1, “r” is an integer of 2 to 6, “m” and “n” each represent an integer of 0 to 600, a sum of “m” and “n” further being 50 to 600, 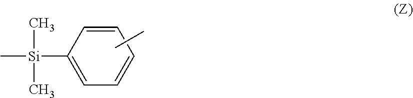
(Z) being a dimethylphenylsilylene group in an ortho-, meta-, or para-position, and 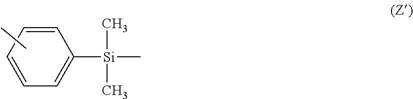
(Z′) being a dimethylphenylsilylene group in an ortho-, meta-, or para-position.

17. The curable perfluoropolyether adhesive composition according to claim 14, wherein the component (A) is a linear perfluoropolyether compound represented by the following general formula (1): 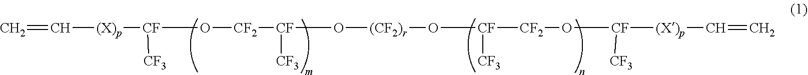
wherein X represents —CH₂—, —CH₂O—, —CH₂OCH₂—, or —Y—NR¹—CO—, Y is a group represented by —CH₂— or the following structural formula (Z), R¹ represents a hydrogen atom, a methyl group, a phenyl group, or an allyl group, X′ represents —CH₂—, —OCH₂—, —CH₂OCH₂—, or —CO—NR²—Y′—, Y′ is a group represented by —CH₂— or the following structural formula (Z′), R² represents a hydrogen atom, a methyl group, a phenyl group, or an allyl group, “p” is independently 0 or 1, “r” is an integer of 2 to 6, “m” and “n” each represent an integer of 0 to 600, a sum of “m” and “n” further being 50 to 600, 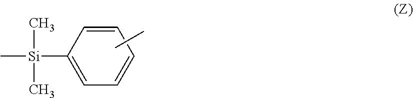
(Z) being a dimethylphenylsilylene group in an ortho-, meta-, or para-position, and 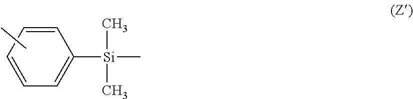
(Z′) being a dimethylphenylsilylene group in an ortho-, meta-, or para-position.

18. The curable perfluoropolyether adhesive composition according to claim 13, wherein the component (A) is a linear perfluoropolyether compound represented by the following general formula (1): 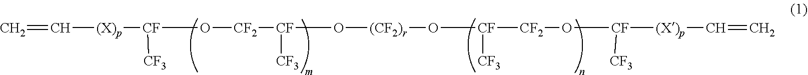
wherein X represents —CH₂—, —CH₂O—, —CH₂OCH₂—, or —Y—NR¹—CO—, Y is a group represented by —CH₂— or the following structural formula (Z), R¹ represents a hydrogen atom, a methyl group, a phenyl group, or an allyl group, X′ represents —CH₂—, —OCH₂—, —CH₂OCH₂—, or —CO—NR²—Y′—, Y′ is a group represented by —CH₂— or the following structural formula (Z′), R² represents a hydrogen atom, a methyl group, a phenyl group, or an allyl group, “p” is independently 0 or 1, “r” is an integer of 2 to 6, “m” and “n” each represent an integer of 0 to 600, a sum of “m” and “n” further being 50 to 600, 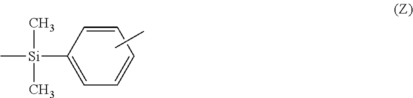
(Z) being a dimethylphenylsilylene group in an ortho-, meta-, or para-position, and 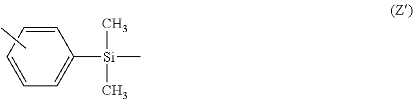
(Z′) being a dimethylphenylsilylene group in an ortho-, meta-, or para-position,
the curable perfluoropolyether adhesive composition contains 0 to 20 parts by mass of the component (D) based on 100 to 80 parts by mass of the component (A), provided that a total of the component (A) and the component (D) is 100 parts by mass,
and the component (B) is a fluorine-containing organohydrogenpolysiloxane having a cyclic siloxane structure.

19. The curable perfluoropolyether adhesive composition according to claim 14, wherein the component (A) is a linear perfluoropolyether compound represented by the following general formula (1): 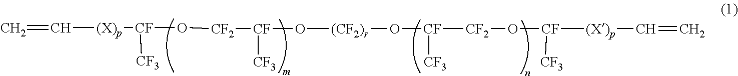
wherein X represents —CH₂—, —CH₂O—, —CH₂OCH₂—, or —Y—NR¹—CO—, Y is a group represented by —CH₂— or the following structural formula (Z), R¹ represents a hydrogen atom, a methyl group, a phenyl group, or an allyl group, X′ represents —CH₂—, —OCH₂—, —CH₂OCH₂—, or —CO—NR²—Y′—, Y′ is a group represented by —CH₂— or the following structural formula (Z′), R² represents a hydrogen atom, a methyl group, a phenyl group, or an allyl group, “p” is independently 0 or 1, “r” is an integer of 2 to 6, “m” and “n” each represent an integer of 0 to 600, a sum of “m” and “n” further being 50 to 600, 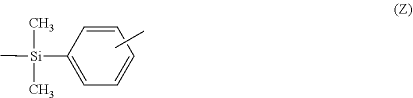
(Z) being a dimethylphenylsilylene group in an ortho-, meta-, or para-position, and 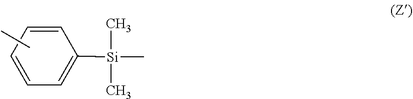
(Z′) being a dimethylphenylsilylene group in an ortho-, meta-, or para-position,
the curable perfluoropolyether adhesive composition contains 0 to 20 parts by mass of the component (D) based on 100 to 80 parts by mass of the component (A), provided that a total of the component (A) and the component (D) is 100 parts by mass,
and the component (B) is a fluorine-containing organohydrogenpolysiloxane having a cyclic siloxane structure.

20. The curable perfluoropolyether adhesive composition according to claim 13, wherein the component (A) is a linear perfluoropolyether compound represented by the following general formula (1): 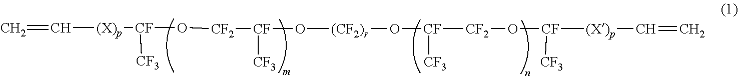
wherein X represents —CH₂—, —CH₂O—, —CH₂OCH₂—, or Y—NR¹—CO—, Y is a group represented by —CH₂— or the following structural formula (Z), R¹ represents a hydrogen atom, a methyl group, a phenyl group, or an allyl group, X′ represents —CH₂—, —OCH₂—, —CH₂OCH₂—, or —CO—NR²—Y′—, Y′ is a group represented by —CH₂— or the following structural formula (Z′), R² represents a hydrogen atom, a methyl group, a phenyl group, or an allyl group, “p” is independently 0 or 1, “r” is an integer of 2 to 6, “m” and “n” each represent an integer of 0 to 600, a sum of “m” and “n” further being 50 to 600, 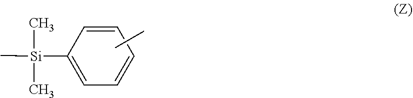
(Z) being a dimethylphenylsilylene group in an ortho-, meta-, or para-position, and 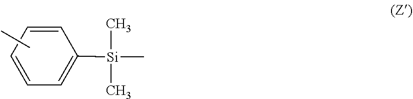
(Z′) being a dimethylphenylsilylene group in an ortho-, meta-, or para-position,
the curable perfluoropolyether adhesive composition contains 21 to 45 parts by mass of the component (D) based on 79 to 55 parts by mass of the component (A), provided that a total of the component (A) and the component (D) is 100 parts by mass,
and the component (B) is a fluorine-containing polyorganohydrogensiloxane having a linear and/or branched siloxane structure.

21. The curable perfluoropolyether adhesive composition according to claim 14, wherein the component (A) is a linear perfluoropolyether compound represented by the following general formula (1): 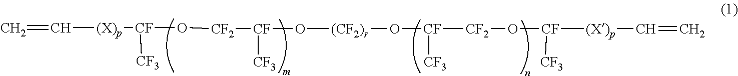
wherein X represents —CH₂—, —CH₂O—, —CH₂OCH₂—, or —Y—NR¹—CO—, Y is a group represented by —CH₂— or the following structural formula (Z), R¹ represents a hydrogen atom, a methyl group, a phenyl group, or an allyl group, X′ represents —CH₂—, —OCH₂—, —CH₂OCH₂—, or —CO—NR²—Y′—, Y′ is a group represented by —CH₂— or the following structural formula (Z′), R² represents a hydrogen atom, a methyl group, a phenyl group, or an allyl group, “p” is independently 0 or 1, “r” is an integer of 2 to 6, “m” and “n” each represent an integer of 0 to 600, a sum of “m” and “n” further being 50 to 600, 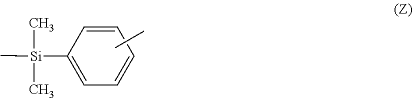
(Z) being a dimethylphenylsilylene group in an ortho-, meta-, or para-position, and 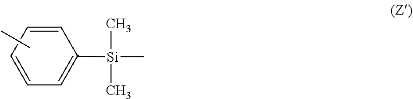
(Z′) being a dimethylphenylsilylene group in an ortho-, meta-, or para-position,
the curable perfluoropolyether adhesive composition contains 21 to 45 parts by mass of the component (D) based on 79 to 55 parts by mass of the component (A), provided that a total of the component (A) and the component (D) is 100 parts by mass,
and the component (B) is a fluorine-containing polyorganohydrogensiloxane having a linear and/or branched siloxane structure.

22. The curable perfluoropolyether adhesive composition according to claim 13, wherein the component (A) is a linear perfluoropolyether compound containing a divalent perfluoropolyether structure including repeating units of a (CF₂O) unit and a (CF₂CF₂O) unit in a main chain,
the curable perfluoropolyether adhesive composition contains 0 to 50 parts by mass of the component (D) based on 100 to 50 parts by mass of the component (A), provided that a total of the component (A) and the component (D) is 100 parts by mass,
and the component (B) is a fluorine-containing organohydrogenpolysiloxane having a linear and/or branched siloxane structure.

23. The curable perfluoropolyether adhesive composition according to claim 14, wherein the component (A) is a linear perfluoropolyether compound containing a divalent perfluoropolyether structure including repeating units of a (CF₂O) unit and a (CF₂CF₂O) unit in a main chain,
the curable perfluoropolyether adhesive composition contains 0 to 50 parts by mass of the component (D) based on 100 to 50 parts by mass of the component (A), provided that a total of the component (A) and the component (D) is 100 parts by mass,
and the component (B) is a fluorine-containing organohydrogenpolysiloxane having a linear and/or branched siloxane structure.

24. The curable perfluoropolyether adhesive composition according to claim 13, wherein the component (A) is a linear perfluoropolyether compound represented by the following general formula (1): 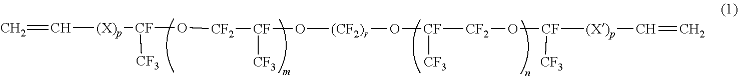
wherein X represents —CH₂—, —CH₂O—, —CH₂OCH₂—, or —Y—NR¹—CO—, Y is a group represented by —CH₂— or the following structural formula (Z), R¹ represents a hydrogen atom, a methyl group, a phenyl group, or an allyl group, X′ represents —CH₂—, —OCH₂—, —CH₂OCH₂—, or —CO—NR²—Y′—, Y′ is a group represented by —CH₂— or the following structural formula (Z′), R² represents a hydrogen atom, a methyl group, a phenyl group, or an allyl group, “p” is independently 0 or 1, “r” is an integer of 2 to 6, “m” and “n” each represent an integer of 0 to 600, a sum of “m” and “n” further being 50 to 600, 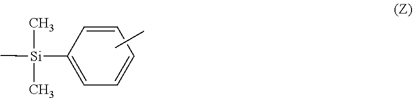
(Z) being a dimethylphenylsilylene group in an ortho-, meta-, or para-position, 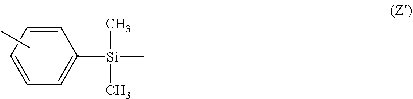
(Z′) being a dimethylphenylsilylene group in an ortho-, meta-, or para-position, and
the linear perfluoropolyether compound containing a divalent perfluoropolyether structure including repeating units of a (CF₂O) unit and a (CF₂CF₂O) unit in a main chain,
the curable perfluoropolyether adhesive composition contains 0 to 50 parts by mass of the component (D) based on 100 to 50 parts by mass of the component (A), provided that a total of the component (A) and the component (D) is 100 parts by mass,
and the component (B) is a fluorine-containing organohydrogenpolysiloxane having a linear and/or branched siloxane structure.

25. The curable perfluoropolyether adhesive composition according to claim 14, wherein the component (A) is a linear perfluoropolyether compound represented by the following general formula (1): 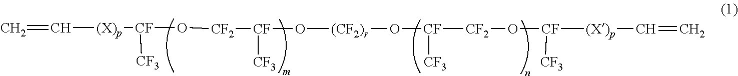
wherein X represents —CH₂—, —CH₂O—, —CH₂OCH₂—, or —Y—NR¹—CO—, Y is a group represented by —CH₂— or the following structural formula (Z), R¹ represents a hydrogen atom, a methyl group, a phenyl group, or an allyl group, X′ represents —CH₂—, —OCH₂—, —CH₂OCH₂—, or —CO—NR²—Y′—, Y′ is a group represented by —CH₂— or the following structural formula (Z′), R² represents a hydrogen atom, a methyl group, a phenyl group, or an allyl group, “p” is independently 0 or 1, “r” is an integer of 2 to 6, “m” and “n” each represent an integer of 0 to 600, a sum of “m” and “n” further being 50 to 600, 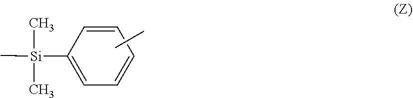
(Z) being a dimethylphenylsilylene group in an ortho-, meta-, or para-position, 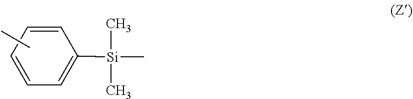
(Z′) being a dimethylphenylsilylene group in an ortho-, meta-, or para-position, and
the linear perfluoropolyether compound containing a divalent perfluoropolyether structure including repeating units of a (CF₂O) unit and a (CF₂CF₂O) unit in a main chain,
the curable perfluoropolyether adhesive composition contains 0 to 50 parts by mass of the component (D) based on 100 to 50 parts by mass of the component (A), provided that a total of the component (A) and the component (D) is 100 parts by mass,
and the component (B) is a fluorine-containing organohydrogenpolysiloxane having a linear and/or branched siloxane structure.

26. The curable perfluoropolyether adhesive composition according to claim 12, wherein the cured product of the curable perfluoropolyether adhesive composition is a non-conductive adhesive having a volume resistivity of 1×10⁹ Ω·cm or more.

27. The curable perfluoropolyether adhesive composition according to claim 13, wherein the cured product of the curable perfluoropolyether adhesive composition is a non-conductive adhesive having a volume resistivity of 1×10⁹ Ω·cm or more.

28. An adhesive comprising the cured product of the curable perfluoropolyether adhesive composition according to claim 12.

29. An adhesive comprising the cured product of the curable perfluoropolyether adhesive composition according to claim 13.

30. An adhesive tape comprising a cured layer of the curable perfluoropolyether adhesive composition according to claim 12 provided on a substrate.

31. An adhesive tape comprising a cured layer of the curable perfluoropolyether adhesive composition according to claim 13 provided on a substrate.
